(19) United States
(12) Patent Application Publication
(10) Pub. No.: US 2014/0011318 A1
(43) Pub. Date: Jan. 9, 2014

(54) METHODS AND SYSTEMS FOR ULTRASONIC SPRAY SHAPING

(71) Applicant: Sono-Tek Corporation, Milton, NY (US)

(72) Inventors: Benjamin Massimi, New Paltz, NY (US); Joseph Reimer, Rhinebeck, NY (US)

(21) Appl. No.: 13/865,739

(22) Filed: Apr. 18, 2013

Related U.S. Application Data
(63) Continuation-in-part of application No. 12/569,169, filed on Sep. 29, 2009, now abandoned.
(60) Provisional application No. 61/100,818, filed on Sep. 29, 2008.

(51) Int. Cl. B05B 17/06

(52) U.S. Cl. CPC B05B 17/06
USPC 438/98; 228/33; 118/612; 118/24; 228/223; 427/600; 239/102.1

(57) ABSTRACT

New and improved ultrasonic spray shaping assemblies, components thereof, and methods for using the assemblies. An ultrasonic spray shaping assembly includes jet block and impact jet components to receive and redirect a single gas stream, whereby to use the single gas stream to shape an ultrasonic spray plume in a desired shape, particularly into a desired width of the plume. Modifications to the components, such as relative positioning, can be used to alter the shape of the spray plume. The present invention can be fabricated in a compact, lightweight design. It has many applications, including but not limited to, the deposition of flux onto a printed circuit board.

### CROSS-REFERENCE TO RELATED APPLICATIONS

This application is a Continuation-In-Part application which claims priority to U.S. Non-Provisional patent application Ser. No. 12/569,169 filed Sep. 29, 2009 and to U.S. Non-Provisional patent application Ser. No. 12/041,912 filed Mar. 4, 2008 that claims the benefit of U.S. Provisional Patent Application Ser. No. 61/100,818 filed Sep. 29, 2008, the disclosures of which are incorporated by reference in their entirety.

### FIELD OF THE INVENTION

The present invention relates generally to the field of forming coatings. More particularly, the present invention relates to the field of ultrasonic nozzle plume spray shaping.

### BACKGROUND OF THE INVENTION

Currently, foodstuffs and food packaging materials are routinely coated with various liquid-state chemicals or ingredients. Depending on the particular application, these chemicals may either remain in the liquid state, evaporate, or polymerize/solidify to form a solid coating. For example, while being manufactured (i.e., prior to being wrapped in a waxy paper sleeve and prior to being inserted into a cardboard package that is then placed on the shelves of a grocery store), some crackers are coated with a thin layer of oil. Similarly, commercially manufactured tortilla chips are typically sprayed with one or more chemical preservatives to extend their shelf life.

Two types of technologies are currently available to apply such liquid-state coatings: pressure spraying and spinning disc spraying. Pressure spraying technology is analogous to the technology used while spraying one's lawn with a garden hose. In other words, foodstuffs or food packaging materials are coated by a liquid emitted from one or more pressurized nozzles. Typically, such nozzles are located at least above and below the foodstuffs or food packaging materials being coated.

Spinning disc spraying involves a battery (i.e., a series) of spinning discs located in a chamber. These discs are angled and positioned in an application-specific configuration relative to the foodstuffs or food packaging materials to be coated. A stream of liquid is then released onto the discs as the discs are spinning. As the liquid is expelled from the surface of the discs by centrifugal force, a rainforest-type of liquid mist is generated all over the chamber in which the discs are located. The foodstuffs or food packaging materials that pass through the chamber are then coated on all sides by the liquid.

Ultrasonic nozzles are known to produce a low velocity atomized spray plume. It is desirable to control the deposition of the micron sized atomized drops in the spray plume produced by the ultrasonic nozzle. Due to the small size and thus light weight of the atomized drops, the spray plume from an ultrasonic nozzle is easily disturbed by air currents in the coating facility. If the atomized drops in the plume are not directed to a desired location in some manner, many or all of the drops.

One current method of shaping the plume produced by an ultrasonic nozzle consists of two streams of gas shearing the plume in order to produce a spray angle and direct the atomized liquid droplets to the substrate. In some embodiments one of the two gas streams, or a third gas stream, is used to redirect the entrained droplets perpendicular to the original direction of the shearing gas streams. The interaction of two and sometimes three separate gas streams often causes the pattern deposited on the substrate to exhibit non-uniformity. The use of multiple gas streams to shape the ultrasonic spray plume requires precise control of each stream to produce a uniform spray pattern.

Regardless of which of these methods is used, however, the coatings formed are relatively thick and are not uniform. Also, particularly in the spinning disc method, a significant amount of liquid is wasted as the liquid coats the walls of the chamber instead of the foodstuffs or food packaging materials.

The present inventors have identified significant deficiencies associated with the existing processes. The use of multiple, precisely controlled gas streams to shape and/or direct the ultrasonic spray plume raises issues associated with the difficulty of controlling the various gas streams and hence the spray plume. While it is possible to shear the atomized liquid off the tip of the ultrasonic nozzle using a sheet of gas as produced by an air knife to direct the atomized droplets, this will not provide an acceptable pattern width. The pattern width will be only slightly greater than the original ultrasonic spray plume.

### SUMMARY OF THE INVENTION

At least in view of the above, it would be desirable to provide methods for forming coatings on foodstuffs and/or food packaging materials wherein the resulting coatings are relatively thin. In addition, it would be desirable to provide methods for forming coatings on foodstuffs and/or food packaging materials wherein the coatings are uniform and wherein the amount of liquid being used is minimized. Additionally, it would be advantageous to overcomes the shortcomings of the currently available methods by using a single gas stream to entrain the atomized drops of the ultrasonic spray plume in such a way as to spread them at an angle, which will produce a spray pattern that is wider than the original ultrasonic spray plume.

The foregoing needs are met, to a great extent, by certain embodiments of the present invention. According to one embodiment, a spraying mechanism is provided. The spraying mechanism includes a nozzle that itself includes an atomizing section. The nozzle also includes an intermediate section configured to promote ultrasonic-frequency mechanical motion in the atomizing section. The spraying mechanism also includes a surface positioned adjacent to the nozzle and configured to support at least one of a foodstuff and a food packaging material.

According to another embodiment of the present invention, a method of depositing a coating on at least one of a foodstuff and a food packaging material is provided. The method includes coating a portion of the nozzle surface with a liquid. The method also includes mechanically moving the surface at an ultrasonic frequency. In addition, the method also includes positioning at least one of the foodstuff and the food packaging material adjacent to the surface.

In another embodiment of the present invention, an apparatus is provided for shaping the plume of an ultrasonic spray. It has a body including a gas stream input and a liquid stream input; an ultrasonic nozzle connected to the body for receiving the liquid stream and converting the liquid stream to an ultrasonic spray; and an assembly connected to the body for receiving and shaping the gas stream and directing the gas stream relatively perpendicular to the ultrasonic spray to control a plume shame of the ultrasonic spray.

An additional embodiment if for a method for shaping the plume of an ultrasonic spray to deposit flux on a printed circuit board. It comprises receiving a gas stream input and a liquid flux stream input; converting the liquid flux stream to an ultrasonic flux spray; shaping the gas stream; and directing the gas stream relatively perpendicular to the ultrasonic spray to control a plume shape of the ultrasonic flus spray; and directing, using the assembly, the ultrasonic flux spray onto a printed circuit board, whereby to deposit the flux upon the printed circuit board.

Another embodiment, a method for shaping the plume of an ultrasonic spray to deposit material on a fuel cell, comprises receiving a gas stream input and a liquid phosphoric doping material stream input; converting the liquid phosphoric doping material stream to an ultrasonic phosphoric doping material spray; shaping the gas stream; and directing the gas stream relatively perpendicular to the ultrasonic phosphoric doping material spray to control a plume shape of the ultrasonic phosphoric doping material spray; and directing, using the assembly, the ultrasonic phosphoric doping material spray onto a fuel cell first surface, whereby to deposit the phosphoric doping material upon the fuel cell first surface.

In still another embodiment, a means for shaping the plume of an ultrasonic spray to deposit a material on a surface, comprises receiving means for a gas stream input and a liquid stream input; and means for shaping the gas stream; and means for directing the gas stream relatively perpendicular to the ultrasonic spray to control a plume shape of the ultrasonic spray; and means for directing, using the assembly, the ultrasonic spray onto a surface, whereby to deposit the liquid stream upon the surface.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a longitudinal cross-sectional view of an ultrasonic atomizing nozzle arrangement according to a first embodiment of the present invention.

FIG. 2 illustrates a radial cross-section of the ultrasonic atomizing nozzle arrangement illustrated in FIG. 1 taken along line 3-3.

FIG. 3 is a longitudinal cross-sectional view of an ultrasonic atomizing nozzle arrangement according to a second embodiment of the present invention.

FIG. 4 is a side view of a highly controllable ultrasonic nozzle spray arrangement according to a third embodiment of the present invention.

FIG. 5 is a front view of highly controllable ultrasonic nozzle spray arrangement according to a third embodiment of the present invention.

FIG. 6 is a side view of an ultrasonic atomizing nozzle arrangement according to a forth embodiment of the present invention.

FIG. 7 is a perspective view of a food coater according to an embodiment of the present invention.

FIG. 8 is a diagrammatic view of an assembly for controlling the shape of an ultrasonic spray plume.

FIG. 9 and FIG. 10 are diagrammatic views of the assembly of FIG. 8 including exemplary dimensional markings.

FIG. 11 and FIG. 12 are three dimensional top and frontal views of an embodiment of the assembly in operation.

### DETAILED DESCRIPTION

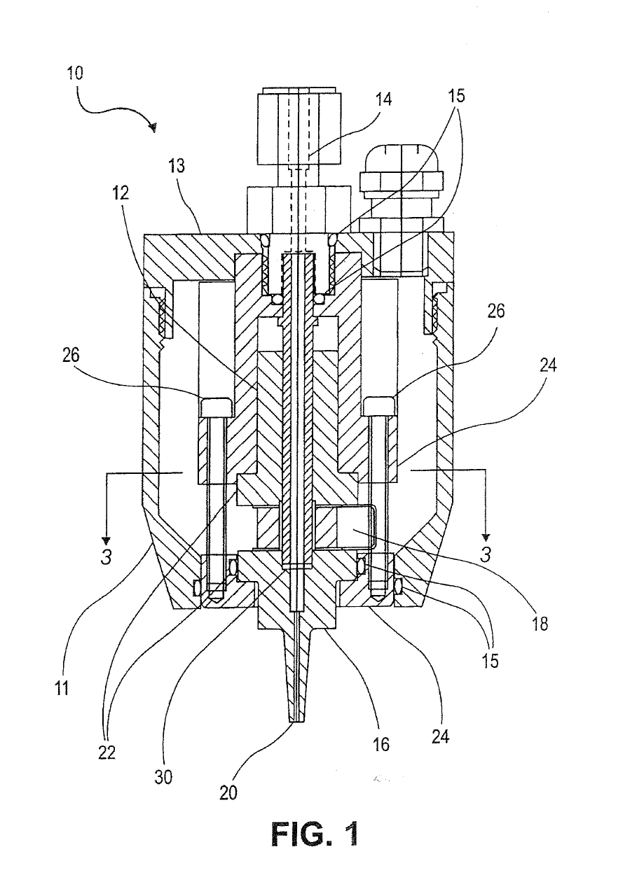

The invention will now be described with reference to the drawing figures, in which like reference numerals refer to like parts throughout. FIG. 1 is a longitudinal cross-sectional view of an ultrasonic atomizing nozzle arrangement 10 according to a first embodiment of the present invention. However, before further discussing the drawing figures any further, a few scientific principles related to ultrasonic atomization are briefly reviewed below.

Ceramic materials (e.g., SiC and Al₂O₃) differ from metals (e.g., titanium and titanium alloys) in a number of ways. For example, in some ceramic materials, such as silicon carbide (SiC) and aluminum oxide (Al₂O₃), the characteristic velocity at which sound waves propagate through these materials is considerably greater than the characteristic velocity at which sound waves propagate any metallic material that is practical for use in constructing an ultrasonic atomizing nozzle. For example, SiC can be manufactured such that the characteristic velocity of sound therein is between 2.3 and 2.7 greater than the characteristic velocity of sound in a Ti-6Al-4V titanium alloy.

When implementing an ultrasonic atomization method according to certain embodiments of the present invention, capillary waves are produced in a liquid coating that is present on a solid surface that is vibrating at an ultrasonic frequency. Under such conditions, the number median drop size (d_{N,0.5}) of the drops formed is calculated as follows:

d_{N,0.5}=0.34(8πs/pf²)^{1/3},

where f=the operating frequency of the nozzle, p=the density of the liquid coating the surface and s=the surface tension of the liquid. Hence, as the operating frequency, f, increases, the number median drop size (d_{N,0.5}) decreases.

In order to form capillary waves that are suitable for ultrasonic atomization, it is desirable to suppress the formation of waves that are not perpendicular to the solid surface from which the liquid film absorbs vibrational energy. In order to suppress the formation of such non-perpendicular waves, the largest diameter of any active nozzle element is limited. More specifically, the diameter is limited to a length that is below one-fourth of the wavelength, λ, of an acoustic wave in the material from which the atomizing surface is formed.

The wavelength, λ, of an acoustic wave in such a material is calculated as follows:

λ=c/f,

where c=the characteristic velocity at which sound waves propagate through a ceramic material. Thus, for a given operational frequency, materials having higher characteristic velocities, c, at which sound waves propagate there through correspond to longer wavelengths. Hence, such materials allow for a larger nozzle diameter at a given frequency.

When the diameter of the nozzle becomes so small that the nozzle becomes impractical to make or use, the practical operating frequency of the nozzle is reached. As such, in metallic nozzles according to the prior art (i.e., in nozzles where the vibrating surface is metallic), the practical upper limit of the operating frequency, f, is approximately 120 kHz. In ceramic nozzles, the upper limit of the operating frequency, f, is raised to approximately 250 kHz. Thus, for a given liquid, d_{N,0.5} is reduced by a factor of (120/250)^{2/3}=0.61.

Keeping in mind the above-mentioned characteristics of materials, one of skill in the art will appreciate that, at a given operating frequency, f, ceramic nozzles can be operated at a greater flow rate than their metallic counterparts. In other words, the diameter of the nozzle can remain larger in a ceramic nozzle than in a metallic nozzle, as can stems, the area of the atomizing surface, and/or liquid feed orifices that may be included to lead liquid to the nozzle.

As mentioned above, FIG. 1 is a longitudinal cross-sectional view of an ultrasonic atomizing nozzle arrangement 10 according to a first embodiment of the present invention. The nozzle 10 illustrated in FIG. 1 includes a rear horn 12 that functions as an interface section. As such, the rear horn 12 is configured to allow the introduction of a liquid into the nozzle 10.

The rear horn 12 illustrated in FIG. 1 is directly connected to a liquid inlet 14. However, the rear horn 12 may be directly or indirectly connected to any component that will allow for flow of a liquid into the nozzle 10. The liquid inlet 14 may be affixed to the rear horn 12 in any manner that would become apparent to one of skill in the art upon practicing the present invention (e.g., a pressure seal or an adhesive). Although not illustrated in FIG. 1, the liquid inlet 14 is typically connected, either directly or indirectly, to a source of liquid such as, for example, a tank containing water based or oil based or solvent based food coating ingredients, in a solution or in a suspension mode.

According to certain embodiments of the present invention, the rear horn 12 is either made entirely from a ceramic material or portions of the rear horn 12 are made from a ceramic material. However, according to other embodiments of the present invention, the rear horn 12 is fabricated either partially or entirely from a metal. For example, the rear horn 12 may be made from silicon carbide (SiC) or aluminum oxide (Al₂O₃).

The nozzle 10 illustrated in FIG. 1 also includes a front horn 16 that is configured to function as an atomizing section. The front horn 16, according to certain embodiments of the present invention, can include one or more portions made from a ceramic material (e.g., SiC or Al₂O₃) or can be made entirely from one or more ceramic materials. The front horn 16 is configured to form drops of the liquid introduced into the nozzle 10 through the rear horn 12. These drops can, according to certain embodiments of the present invention, have number median drop sizes (d_{N,0.5}) of less than approximately 20 microns (e.g., approximately 17 microns), although larger drop sizes are also within the scope of certain embodiments of the present invention. Also, according other embodiments of the present invention, the front horn 16 is configured to form drops of liquid having number median drop sizes of between approximately 7 microns and approximately 10 microns.

One of the advantages of the nozzle 10 illustrated in FIG. 1 is that it increases the rate at which a liquid introduced into the nozzle 10 may be atomized. As discussed above, ceramic material which can be used in embodiments of the present invention have higher characteristic velocities at which sound waves propagate there through, a larger front nozzle diameter is allowable for a given frequency. Therefore, according to certain embodiments of the present invention, the front horn 16 is configured to allow the liquid introduced into the nozzle 10 to flow through the nozzle 10 at a rate above approximately 60 ml per minute (1 gallon per hour). According to other embodiments of the present invention, the front horn 16 is configured to allow the liquid to flow through the nozzle 10 and the front horn 16 at a rate of approximately 1200 ml per minute (20 gallons per hour).

In the nozzle 10 illustrated in FIG. 1, the rear horn 12 and the front horn 16 have substantially equal lengths. However, according to other embodiments of the present invention, the rear horn 12 and the front horn 16 have different lengths. According to certain embodiments of the present invention, a ceramic nozzle operates at 250 kHz and the rear horn 12 and front horn 16 both have lengths equal to, for example, 3λ/4, since horns of such length are substantially easier to manufacture than horns having lengths of λ/4. According to certain other embodiments of the present invention, a ceramic nozzle operates at 120 kHz and both horns 12, 16 have lengths λ/4, which are relatively practical to manufacture.

The nozzle 10 illustrated in FIG. 1 also includes a transducer portion 18 that includes a pair of transducers that are positioned in an intermediate section of the nozzle 10 that is located between the rear horn 12 and the front horn 16. The transducers in the transducer portion 18 are piezoelectric transducers and are configured to promote ultrasonic-frequency mechanical motion in the front horn 16. In other words, the transducers in the transducer portion 18 provide the mechanical energy to cause the atomizing surface 20 located on the front horn 16 illustrated in FIG. 1 to vibrate at an ultrasonic frequency with sufficient amplitude to result in atomization. Although two transducers are discussed above as being included in the transducer portion 18 illustrated in FIG. 1, a single transducer and/or any other component or system that can be used to cause ultrasonic-frequency mechanical motion in the front horn 16 is also within the scope of the present invention.

The rear horn 12 and the front horn 16 each include a flange 22. A cover, in the form of a ring 24, is positioned adjacent to each of the flanges 22 illustrated in FIG. 1. A plurality of fasteners, in the form of bolts 26, are also illustrated in FIG. 1 and connect the two rings 24.

The above-discussed bolts 26 and rings 24 are components of a clamping mechanism that is positioned adjacent to the exterior surfaces of the rear horn 12 and front horn 16, respectively. This clamp is configured to keep the front horn 16 and the rear horn 12 adjacent to the transducer portion 18. In addition, this clamp is also configured to apply predetermined compressive forces to the transducer/horn assembly, thereby assuring proper mechanical coupling amongst the various elements of the assembly.

By using the clamp arrangement illustrated in FIG. 1, the rear horn 12 and the front horn 16, one or both of which may be made from a metallic or ceramic material, do not need to include threaded holes that directly accommodate the bolts to be kept adjacent to each other. This reduces the likelihood that either the rear horn 12 or the front horn 16 will crack as threaded holes are formed therein or that the threads formed in such holes will lack the shear strength to sustain the amounts of pressure to which they may be subjected (e.g., over 10,000 psi).

Also illustrated in FIG. 1 are a front shroud 11, a rear shroud 13 and a plurality of O-rings 15. Together, the front shroud 11 and the rear shroud 13 provide a housing for the nozzle 10 and the O-rings 15 provide a plurality of seals within this housing.

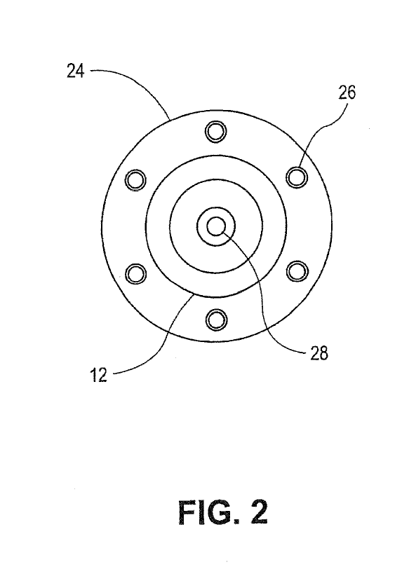

FIG. 2 illustrates a radial cross-section of the ultrasonic atomizing nozzle arrangement 10 illustrated in FIG. 1 taken along line A-A. As illustrated in FIG. 2, the rear horn 12 has a fluid inlet 28 at the center thereof. This fluid inlet 28 is part of the liquid conduit 30 illustrated in FIG. 1 that allows liquid to travel from the liquid inlet 14 all the way to the atomizing surface 20 on the front horn 16.

As also illustrated in FIG. 2, the ring 24 extends around the rear horn 12 and has a plurality of bolts 26 positioned at various locations about the circumference thereof. Although a ring 24 is illustrated in FIG. 2 as making up a portion of the above-discussed clamp, other components may be positioned adjacent to the flanges 22 illustrated in FIG. 1. For example, square or rectangular plates may be used. Also, although six regularly spaced bolts 26 are illustrated around the periphery of the ring 24 in FIG. 2, other distributions of one or more bolts 26 or other fasteners may be used according to other embodiments of the present invention.

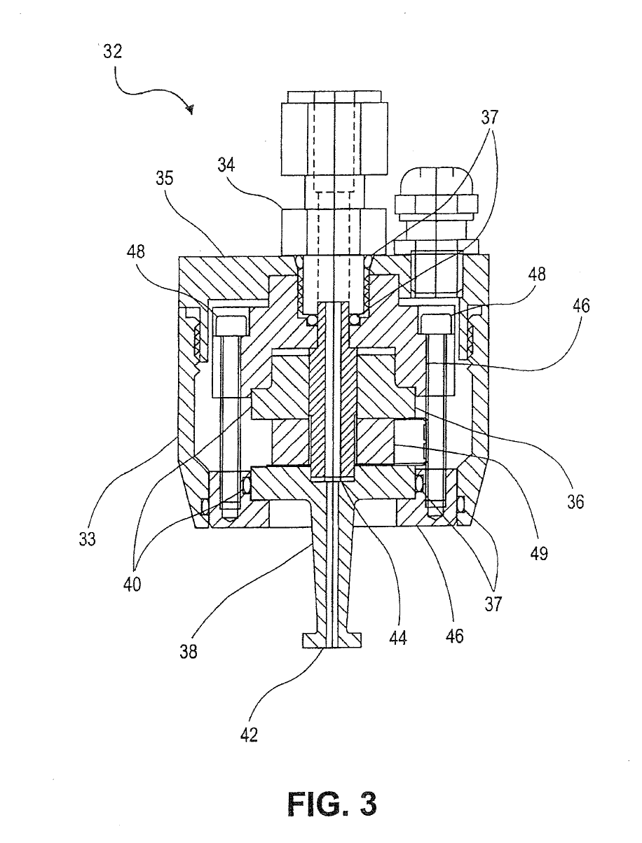

FIG. 3 is a longitudinal cross-sectional view of an ultrasonic atomizing nozzle arrangement 32 according to a second embodiment of the present invention. Like the nozzle 10 illustrated in FIG. 1, the nozzle 32 illustrated in FIG. 3 includes a liquid inlet 34, a rear horn 36 and a front horn 38, each having a flange 40. The front horn 38 also includes an atomizing surface 42 that is positioned at one end of a liquid conduit 44. In addition, the nozzle 32 illustrated in FIG. 3 includes a clamp arrangement that includes a plurality of rings 46 and bolts 48. Further, the nozzle 32 also includes a transducer portion 49 that includes a pair of transducers that are positioned in an intermediate section of the nozzle 32 that is located between the rear horn 36 and the front horn 38. Also illustrated in FIG. 3 are a front shroud 33 and a rear shroud 35 that, together, provide a housing for the nozzle 32 and a plurality of O-rings 37 that provide a plurality of seals within this housing.

One way in which the nozzle 32 illustrated in FIG. 3 differs from the nozzle 10 illustrated in FIG. 1 is that the front horn 38 illustrated in FIG. 3 is approximately 3 times a long as the rear horn 36 illustrated therein. This is particularly representative of the fact that the rear horn 12 and front horn 16 may, according to certain embodiments of the present invention, have different lengths. In fact, according to certain other embodiments of the present invention, the respective lengths of the rear horn and front horn in a given nozzle are multiples or fractions of each other. Under certain operating conditions (e.g., high frequencies), it becomes impractical to manufacture horns having lengths equal to 214. Therefore, horns having lengths equal to multiples of λ/4 are often used under such circumstances.

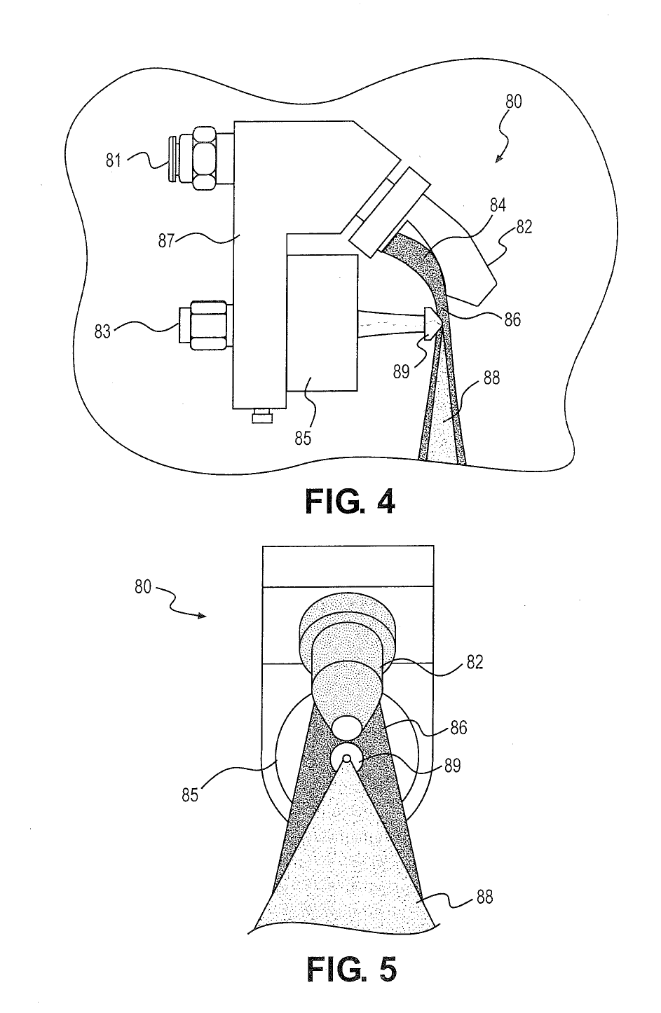

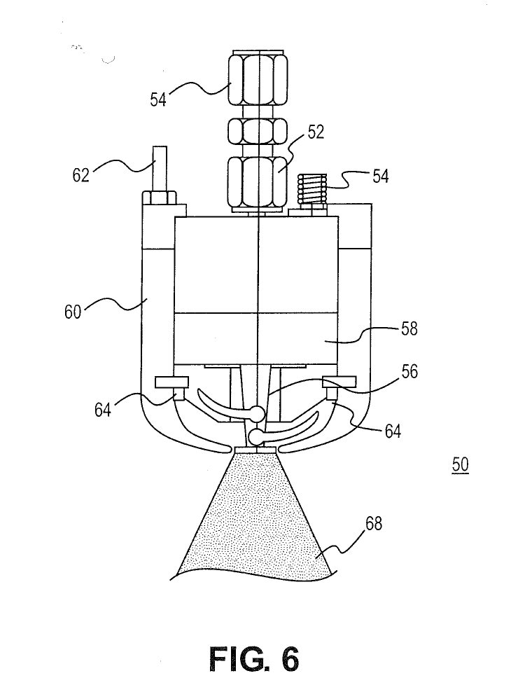

In a third embodiment of the present invention, a highly controllable ultrasonic sprayer 80 is disclosed. FIG. 4 and FIG. 5 illustrate a flat jet air deflector horn 82 is positioned adjacent to the atomizing surface 89 of the ultrasonic nozzle 85, both are located on jet block assembly 87. The ultrasonic nozzle 85 is made from titanium and 316 stainless steel making it non-reactive with most liquids. An air inlet fitting 81 and a liquid inlet fitting 83 are located on jet block assembly 87.

In operation, a controllable source of air is attached to air inlet fitting 81 port and liquid to be atomized is connected to the liquid inlet fitting 83 port. A controllable air stream 84 from the air inlet fitting 81 is sent towards the flat jet air deflector horn 82, which reshapes the controllable air stream 84 into a flattened air pattern 86. The flattened air is deflected toward the atomizing surface 89 of the ultrasonic nozzle 85. Liquid which entered the liquid inlet fitting 83 is atomized by the ultrasonic nozzle 85 and is output at the atomizing surface 89. The atomized liquid is entrained in the flattened air pattern 86 producing a fan pattern 88 which is composed of air and the atomized liquid.

The area of the fan pattern 88 as well as the velocity and impact force of the atomized liquid particulate is related to the velocity of the controllable air stream 84. The ultrasonic nozzle 85 can operate in a frequency range of 25-120 kHz allowing for a variety of drop sizes with a flow rate from 1 ml/minute to 99 ml/minute.

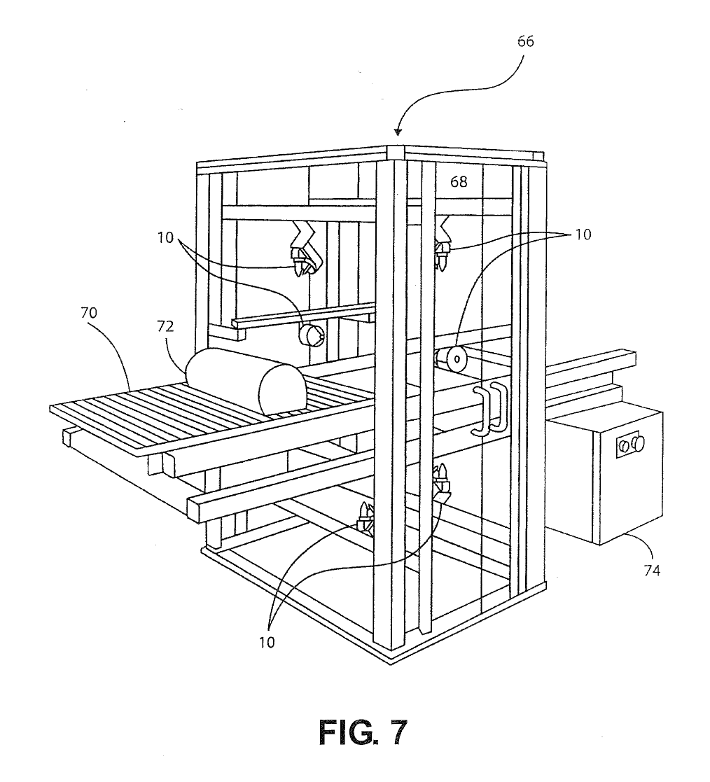

FIG. 6 is a side view of a ceramic-containing ultrasonic atomizing nozzle 50 arrangement according to a forth embodiment of the present invention. The arrangement 50 includes a liquid inlet fitting 52 through which liquid enters the nozzle. Also included is an input connector 54 from a broadband ultrasonic generator (not illustrated). The input connector 54 conveys ultrasonic vibrations from the generator into components of the arrangement 50 (i.e., the connector 54 causes certain components of the arrangement 50 to vibrate back and forth at an ultrasonic frequency).

Also included in the arrangement 50 are a nozzle stem 56 through which liquid in the arrangement 50 is sprayed and a nozzle body 58 that supports the stem 56. The nozzle stem 56 and body 58 are included within a nozzle housing 60 to which is also connected the liquid inlet fitting 52 and the input connector 54.

A compressed air inlet 62 is also connected to the housing 60. This inlet 62 is used to introduce compressed air into the arrangement 50 and the compressed air is output from the arrangement 50 through two compressed air outlets 64 located adjacent to the nozzle stem 56. In operation, low velocity rotational air is expelled from the air outlets 64 to produce a wide and stable spray pattern of liquid from the nozzle stem 56.

According to certain embodiments of the present invention, the arrangement 50 produces a conical spray pattern 68 that is between approximately 2″ and approximately 6″ in diameter, depending upon the frequency used and the distance between the nozzle stem 56 and the surface/item being sprayed/coated. For example, a 25 kHz frequency will produce a mean water drop size of 70 microns and the frequencies of 35 kHz, 48 kHz, 60 kHz and 120 kHz will produce 49 micron, 38 micron, 41 micron and 18 mean micron size water drops, respectively.

As will be appreciated by those of skill in the art upon practicing one or more embodiments of the present invention, liquids other than water may have different drop sizes at the same frequencies, depending at least upon the viscosity of the alternate liquids.

According to yet another embodiment of the present invention, a method of atomizing a liquid is provided. The method includes coating a portion of an atomizing surface (e.g., the atomizing surface 20 illustrated in FIG. 1) with a liquid. According to certain embodiments of the present invention, this coating step includes introducing the liquid onto the surface at a rate of between approximately 60 ml/minute (i.e., 1 gal/hour) and approximately 1200 ml/minute (i.e., 20 gal/hour).

The method also includes mechanically moving (i.e., vibrating) the surface at an ultrasonic frequency. According to certain embodiments of the present invention, this mechanically moving step includes mechanically moving the surface at a frequency of between approximately 25 kHz and approximately 250 kHz. According to other embodiments of the present invention, the mechanically moving step includes mechanically moving the surface at a frequency of between approximately 25 kHz and less than approximately 12 kHz (e.g., approximately 60 kHz).

The above-discussed method also includes forming drops of the liquid having number median drop sizes of less than approximately 20 microns. According to certain embodiments of the present invention, the coating step comprises selecting liquids containing an organic solvent. According to these embodiments, the number median drop size of the drops formed during the above-discussed forming step is between approximately 7 microns and approximately 10 microns.

The above-discussed method also includes passing the liquid through an interface section that includes a ceramic material before performing the coating step. This passing step may be performed, for example, by passing liquid through either the rear horn 12 or the front horn 16 illustrated in FIG. 1, so long as at least one of these horn 12, 16 has a ceramic material incorporated therein.

According to other embodiments of the present invention, the above-discussed method includes clamping the interface section to an atomizing section that includes the atomizing surface. This clamping step is typically an alternative to having to use fasteners that would have to be screwed directly into components of a nozzle used to implement the above-discussed method.

According to certain embodiments of the present invention, the above-discussed atomizing nozzle arrangements 10 are configured to be used in the food industry and are operated in a manner consistent therewith. For example, according to certain embodiments of the present invention, a foodstuff and/or a food packaging material is coated utilizing the above-discussed atomizing nozzle arrangements 10 in an ultrasonic spraying process.

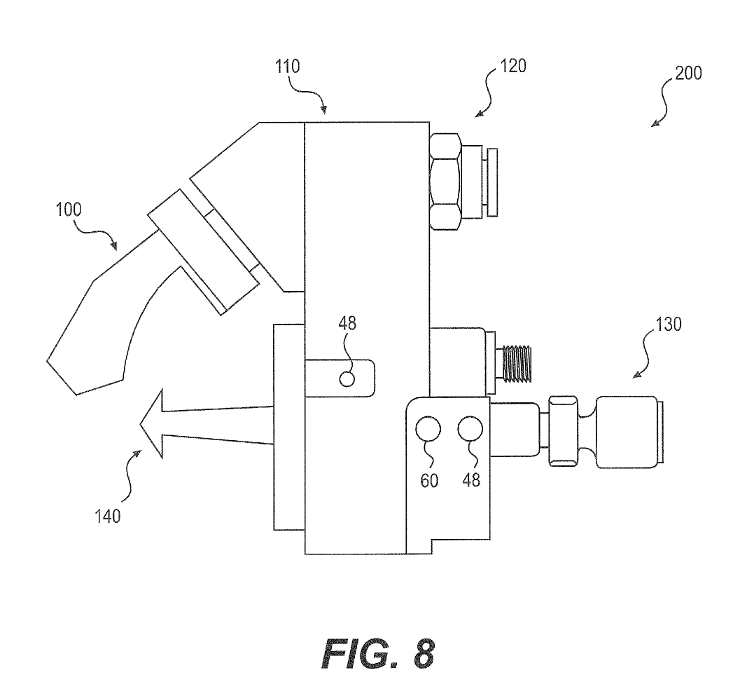

FIG. 7 illustrates a perspective view of a food coater 66 according to an embodiment of the present invention. The food coater 66 includes a plurality of nozzle arrangements 10 located within a chamber 68. Extending through the chamber 68 is a conveyor belt 70 upon which is positioned a foodstuff 72. Also, operably connected to and positioned external to the chamber 68 is a control system 74.

The control system 74 illustrated in FIG. 7, according to certain embodiments of the present invention, is computerized and connected to at least one of the nozzle arrangements 10 and the conveyor belt 70. The control system 74 may be configured to control one or more of the following: a triggering mechanism that turns the spraying system on and off (i.e., an on/off switch), nozzle power, liquid flow rate of the liquid entering the spraying mechanism (i.e., the nozzle arrangements 10 or the food coater 66 itself), air shaping, and the speed at which the top surface of the conveyor belt 70 moves relative to the nozzle arrangements 10. According to certain embodiments of the present invention, the nozzle arrangements 10 are controlled to operate at approximately one or more of the following frequencies: 25, 35, 48, 60 and 120 KHz. However, operation at other frequencies is also within the scope of the present invention.

One advantage provided by the food coater 66 illustrated in FIG. 5 is the ability to spray a very thin, controlled and uniform layer of a chosen liquid onto either a foodstuff or a food packaging material. Because the coatings are thinner than those formed using currently available processes, less liquid is used than in currently available processes.

According to certain embodiments of the present invention, the chosen liquid includes one or more of the following: an anti-microbial solution, an anti-enzymatic browning solution, an edible oil, a liquid flavoring, a liquid spice, a nutriceutical, a protein solution, a peptide solution, a glaze, an anti-stick baking pan release solution, a sterilant, hydrogen peroxide, a food-grade acid, a food-grade alcohol, propionic acid, lactic acid, malic acid, adipic acid, and ethanol. Since at least some of these liquids are particularly costly, certain embodiments of the present invention allow for significant economic savings by the manufacturers of foodstuffs and/or food packaging materials. For example, the cost associated with the application of natural anti-microbial liquids to baked goods can be greatly reduced by reducing the amount of liquid needed, sometimes by as much as 67% or even 75%.

Also, coatings according to certain embodiments of the present invention are more uniform than those resulting from currently available processes. This is due to the fact that droplets formed by the spraying mechanisms including nozzles 10 according to certain embodiments of the present invention produce small and uniform droplets. As such, if a more uniform preservative coating is being sprayed on a foodstuff, utilizing coating methods according to certain embodiments of the present invention will increase the shelf-life of the foodstuff.

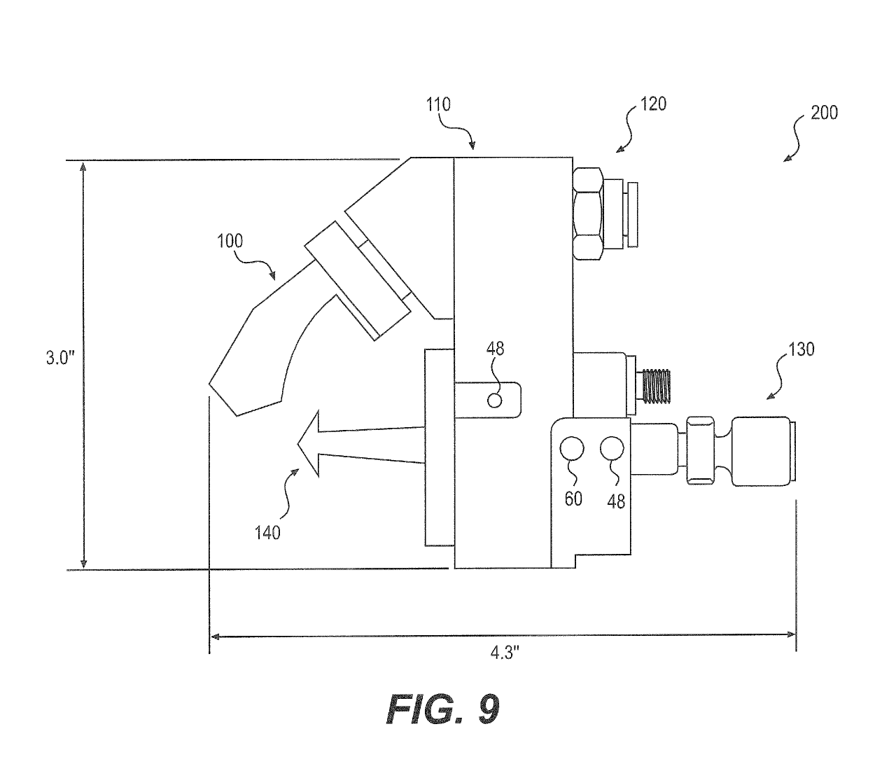

An impact spray shaping assembly 20 of the FIG. 8 consists of four main components: an impact jet (100), a jet block (110), spray shaping gas supply fitting (120) and the ultrasonic nozzle (140). Liquid is supplied to the ultrasonic nozzle through the liquid supply fitting (130). The jet block (110) was designed to hold the ultrasonic nozzle (140) and the impact jet (100) in the required orientation in relation to each other. The jet block (110) also provides the means for air to be supplied to the impact jet (100) through the spray shaping gas supply fitting (120).

The impact jet (100) is a flat fan hydraulic nozzle produced by numerous companies, for example the K type nozzle. The jet 100 is typically used in washing applications requiring a high impact force. Typical spray angles are available from 15° to 50° for the spoon shaped deflecting face design. Impact spray shaping assemblies 200 of the present invention have been produced with jets 100 at angles from 15° to 50°, with equal amount of success, especially with a jet at 15°, 35° and 50°.

FIG. 1 shows a reciprocating fluxer operated of the present invention in which the jet is 50°. The deflection angle is related to the spray angle. For example, the 15°, 35° and 50° spray angles, the deflection angles are 5°, 35° and 55°, respectively. The deflection angle and spray angle correlation may change from manufacturer to manufacturer depending on design. They are typically referred to as nozzles, although referred to herein as a jet due to the use in this application and to avoid confusion when referencing the ultrasonic nozzle 140. They are typically manufactured in brass and 303 stainless steel or any other corrosion resistant, non or low reacting material. In this described embodiment there is used a 316-stainless steel piece due to the corrosive nature of fluxes.

In an additional embodiments, the jet can be Teflon (PTFE). This material has provided the same deflection and spray angles as brass and 303 stainless steel. The impact jet (100) is available in many different sizes with different spray angles, deflection angles and orifice sizes. The impact jet (100) used is selected based upon size, weight and air flow specifications decided appropriate for the application, for example the fluxer application described below.

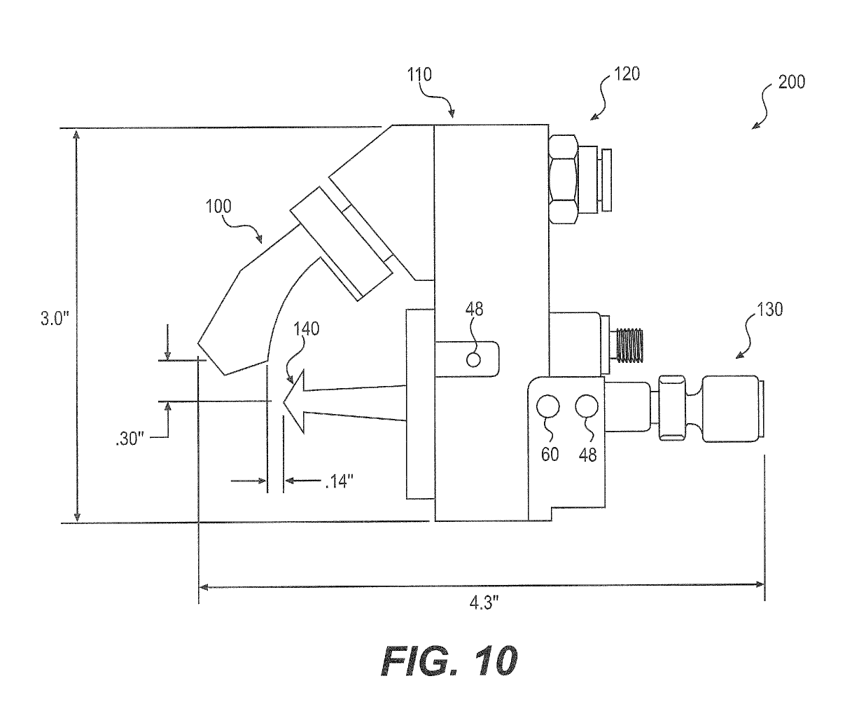

The main function of the jet block (110) is to support impact jet (100) and the ultrasonic nozzle atomizing surface (140) in the correct orientation in relation to each other. The correct orientation provides that the ultrasonic spray is sheared perpendicular to the atomizing surface and that all of the atomized liquid drops are entrained in the flat fan gas stream. The jet block (110) also can support the gas supply fitting (120) and provides a path for the gas to exit the gas supply fitting (120) and enter the impact jet (100). The current jet block (110) design provides through-holes (not shown) in order to use a screw to thread into a flat on the body of ultrasonic nozzle (140). The jet block (110) also has two locations in which brackets (not shown) can be placed to orient the ultrasonic nozzle (140) atomizing surface in relation to the exit of the gas stream from the impact jet (100). Brackets can be designed and fabricated for any number of nozzles other than the one pictured in FIG. 200. The described jet block (110) is designed around the size of the ultrasonic nozzle (140), the size of the impact jet (100) and the 55° deflection angle of the impact jet (100) shown in FIG. 9 and FIG. 10 below. The jet block (110) is made, in the described embodiment, from Ertalyte Tex. due to the light weight and corrosion resistance nature of the material and its suitability for the fluxing application described below. The jet block (110) can be produced from any number of materials including aluminum, stainless steel, Delrin, Teflon, etc. The selected material desirable retains dimensional stability and provides suitable corrosion resistance for the desired application. The jet block 110 is made, in the described embodiment, from Ertalyte Tex. due to the light weight and corrosion resistance nature of the material and its suitability for the fluxing application described below. Ertalyte is semi crystalline, un-reinforced, thermoplastic polyester based on polyethylterephthalate (PET-P). It has an excellent dimensional stability together with superb wear resistance, a low co-efficient of friction, high power, & resistance to fairly acidic solutions. Ertalyte's properties make it particularly suitable for the construction of precision perfunctory parts which are capable of supporting high loads & enduring wear circumstances. Ertalyte PETP can be machined to accurate detail on normal metal gear. Therefore, the block 110 can be produced from any number of materials including aluminum, stainless steel, Delrin, Teflon, etc. The selected material desirable retains dimensional stability and provides suitable corrosion resistance for the desired application.

With reference now to FIG. 9 and FIG. 10, jet block (110) is designed, that is shaped, dimensioned and positioned, to support the impact jet (100) and the ultrasonic nozzle (140) atomizing surface in a particular relation to each other. The design reference in FIG. 9 and FIG. 10 is based on an ultrasonic nozzle, which can atomize flow rates from approximately 10 ml/min to 70 ml/min. The ultrasonic atomizing surface diameter, i.e. the tip of nozzle 14, can range from 0.23 inches to 0.75 inches (0.46 inches used in the described embodiment). The edge of the deflection surface on the impact jet (100) can be loaded from 0.03 inches to 0.75 inches (0.14 inches used in this application) horizontally from the center of the atomizing surface and 0.06 inches to 0.63 inches (0.30 inches used in the described embodiment) vertically from the atomizing surface. The provided dimensions are based on the 50° impact jet (100) in system 200. The dimensions can be altered based on other impact jet designs available. Gas is supplied to the impact jet (100) at between 5 and 15 psi. The plume diameter when sheared by the impact gas stream is approximately equal to or less than the atomizing surface diameter. The plume diameter depends on the flow rate and power being supplied to the ultrasonic nozzle. The pattern width produced on the substrate can range from one inch to six inches. This depends on liquid flow rate, gas pressure and height of the assembly from the substrate. An example from one set of testing, using components and materials as described above, is: flow rate is equal to 48 ml/min, gas pressure is equal to 10 psi, height is equal to 6 inches from substrate, resulting pattern width is equal to 3 inches.

Ultrasonic nozzle (140) comprises any appropriate ultrasonic nozzle, for example an appropriate 8700-series model of the type manufactured and sold by the Sono-Tek Corporation. The gas supply fitting (120) and liquid supply fitting (130) comprise conventional components well known to the reader.

The assembly uses a single gas stream, which is converted into a flat fan pattern, to entrain the drops in the ultrasonic spray plume. The gas stream is created by the flow of pressurized gas introduced into the assembly through the spray shaping gas supply fitting (120). The gas is forced through the jet block (110) and introduced to the impact jet (100). The flat fan spray angle is produced by the impact of the gas stream on the deflecting surface of the impact jet (100). The deflecting surface produces not only the spray angle and converts the gas stream to a flat fan pattern, but the orientation shears the ultrasonic spray plume perpendicular to the ultrasonic nozzle atomizing surface (140). Through-holes on the jet block (110) and threaded holes on the body of the ultrasonic nozzle (140) insure that the atomizing surface of the ultrasonic nozzle (140) is oriented correctly in relation to the Impact jet (100). The ultrasonic spray plume is entrained in the spray angle of the flat fan pattern produced by the impact jet (100). Due to the entrainment of the ultrasonic spray plume in the flat fan, the pattern width deposited on the substrate can be many times the diameter of the ultrasonic spray plume. The pattern width deposited on the substrate can be affected by several variables. They include: impact jet (100) spray angle, plume size due to liquid flow rate, gas flow rate and pressure of gas stream impacting the deflecting surface and orientation of the impact jet (100) in relation to the ultrasonic nozzle atomizing surface (140).

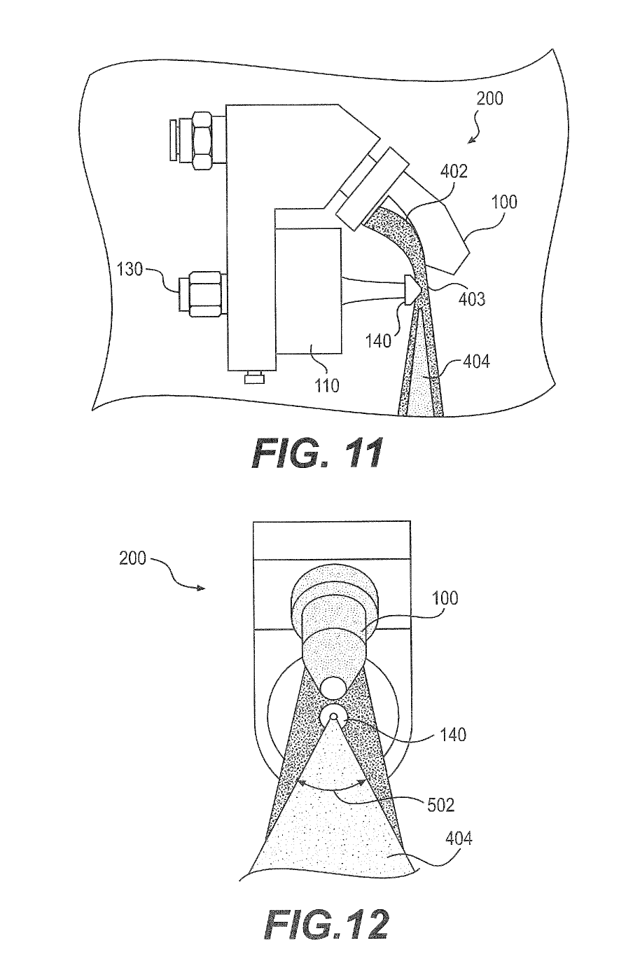

With reference now to FIG. 11 and FIG. 12, FIG. 11 shows a top view of the described assembly 200 in operation, with the gas stream 402 directed, by the described assembly, across the path of the ultrasonic liquid plume 404. FIG. 12 shows the resultant, desired, shaping 502 of the ultrasonic plume 404.

The Impact Spray Shaping Assembly of the present invention produces a pattern width many times the width of the ultrasonic spray plume. The orientation of the Impact Jet (100) and the atomizing surface of the ultrasonic nozzle (140) in relation to each other are unique, as described. Changes in the orientation of the components can be used to alter the pattern width, as described. The Impact Spray Shaping Assembly can be assembled with light weight, compact components in order to be used in reciprocating spray fluxing machines.

One intended use of the Impact Spray Shaping Assembly is in the printed circuit board (PCB) fluxing industry. Prior to components being soldered to a PCB the board must be coated with flux. This is often done by spraying the flux onto the PCB. The PCB is placed on a conveyor and the spray nozzle reciprocates perpendicular to the motion of the PCB. Air atomizing nozzles, nozzles which use high velocity air to break apart (atomize) the liquid, have, here to for, often been used in this application. The Impact Spray Shaping Assembly of the present invention provides significant improvements over air atomizing nozzles in this and other applications. The orifice sizes in air atomizing nozzles are small, relative to ultrasonic nozzles, due to the high velocity required to atomize liquid. The small orifices easily clog. This leads to non-uniform coverage or no coverage if the orifices clog fully. The liquid feed orifice in the ultrasonic nozzle is large, relative to the orifice in an air atomizing nozzle. This alone leads to reduced clogging during operation, but the ultrasonic vibration in the nozzle virtually eliminates the possibility of clogging in the ultrasonic nozzle. The orifice in the Impact jet which supplies the gas stream for spray shaping is also large relative to the spray shaping orifices associated with an air atomizing nozzle. The orifice in the Impact jet can be large due to the difference in air velocity required to entrain ultrasonic atomized drops versus the air velocity required to entrain air atomized drops.

In an additional embodiment, the present invention can be used in solar cell manufacturing. The spraying apparatus and techniques taught by the present invention can by used to solder bus flux silicon solar cells or depositing suspensions for transparent conductive oxide (TCO) layers in thin film solar cell manufacturing.

The present invention can do phosphoric doping and spray pyrolysis applications for production of fuel cells by applying the material to a fuel cells first surface. The present invention can be used to coat Proton Exchange Membranes with catalyst inks such as carbon black and other precious metal suspensions onto nafion membranes.

In another embodiment, the present invention can be utilized to coat baked goods. For example, the present invention could coat the top of a bread or Danish with a ultrafine coating of egg wash to produce a shinny glazed look on the top of the bread or Danish. The present invention could also coat the bread with a micro fine coating of preservative to help keep the bread fresh and keep the bread form growing mold.

The atomized drops produced by the ultrasonic nozzle are ejected from the atomizing surface at very low velocity. The atomized drops produced by an air atomizing nozzle are ejected from the nozzle at very high velocity. Due to the low velocity of the ultrasonic atomized drops they can be entrained by a low velocity gas stream. The high velocity drops produced by an air atomizing nozzle must be entrained by high velocity gas streams in order to change the direction of the drops and produce the desired spray pattern. In the prior art, the high velocity of the atomized drops and the spray shaping gas streams associated with air atomizing nozzles led to clogged orifices and exhaust systems, low transfer efficiency, wasted process chemicals and extended cleaning time of the spray fluxing machines. Air atomizing nozzles typically used two gas streams to create the flat fan spray pattern used in fluxing machines. The interaction of two high velocity gas streams to create the spray pattern led to non-uniformity in the spray pattern if there is a slight difference in pressure, flow or direction of one of the gas streams. The Impact Spray Shaping Assembly of the present invention uses only a single gas stream for spray shaping and thus avoids this issue. This leads to a more consistent pattern over extended production runs. The pattern produced by the Impact Spray Shaping Assembly is unique in the fact that it is not produced by two blended gas streams meeting at a centralized location. The Impact Spray Shaping Assembly pattern is produced by a single gas stream and thus does not require two or more individual streams of entrained atomized drops to meet and produce a uniform pattern.

Other ultrasonic devices, not nozzles, have been used in the spray fluxing of PCBs. These prior art devices use side liquid feed apparatus, which is prone to clogging. They also use multiple gas streams to entrain the atomized drops to produce the desired spray pattern. These ultrasonic devices produce a spray pattern equal or only slightly greater than the pattern width of the atomized liquid. The Impact Spray Shaping Assembly of the present invention has the ability to produce a pattern width many times the width of the ultrasonic plume. The Impact Spray Shaping Assembly is unique in the fact that it has a single gas delivery and a single liquid delivery. Other ultrasonic and air atomizing devices require multiple liquid and gas delivery in order to produce and atomized spray suitable to coat PCBs with flux. The Impact Spray Shaping Assembly of the present invention is unique in its ability to spray in any orientation. This allows the Impact Spray Shaping Assembly to be orientated perpendicular to the conveyor carrying the PCB through the fluxing chamber to the wave solder machine. Other, prior art ultrasonic devices with liquid side feed apparatus must be located on a horizontal plane or the liquid being delivered through the side feed apparatus is not distributed uniformly on the atomizing surface. This causes the spray pattern to be non-uniform and produces an unacceptable coating. Due to the use of an ultrasonic nozzle with a central liquid feed orifice to the atomizing surface the ultrasonic spray plume is not affected by the orientation of the Impact Spray Shaping Assembly of the present invention.

There have thus been provided new and improved ultrasonic spray shaping assemblies, components thereof, and methods for using the assemblies. In accordance with the present invention, the ultrasonic spray shaping assembly includes jet block and impact jet components to receive and redirect a single gas stream, whereby to use the single gas stream to shape an ultrasonic spray plume in a desired shape, particularly into a desired width of the plume. Modifications to the components, such as relative positioning, can be used to easily alter the shape of the spray plume. The present invention can be fabricated in a compact, light-weight design. It has many applications, including but not limited to, the deposition of flux onto a printed circuit board.

It should be noted that other industrial processes are also within the scope of certain embodiments of the present invention. For example, embodiments of the present invention may be used for coating applications in the electronics industry, the medical device industry, the solar energy and fuel cell industries, the glass industry, the textile industry, etc.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for shaping a plume of an ultrasonic spray, comprising:
a body including a gas stream input and a liquid stream input;
an ultrasonic nozzle connected to the body for receiving a liquid stream and converting the liquid stream to an ultrasonic spray; and
an assembly connected to the body for receiving and shaping a gas stream and directing the gas stream relatively perpendicular to the ultrasonic spray to control a plume shape of the ultrasonic spray.

2. The apparatus of claim 1 wherein the assembly includes a hydraulic nozzle for receiving, shaping and redirecting the gas stream to impact the ultrasonic spray and control the plume shape of the ultrasonic spray.

3. The apparatus of claim 2 wherein the hydraulic nozzle comprises a flat fan hydraulic nozzle.

4. The apparatus of claim 3 and further including a block for positioning the hydraulic nozzle relative to the ultrasonic nozzle.

5. The apparatus of claim 1 further including a product comprising flux deposited upon a printed circuit board.

6. A solar cell manufacturing method, comprising utilizing the apparatus of claim 1 to a suspension of transparent conductive oxide (TCO) on a thin film solar cell.

7. The apparatus of claim 1 further including a product comprising solder bus flux for the production of silicon solar cells.

8. The apparatus of claim 1 further including a product comprising phosphoric doping material to be used in a pyrolysis production of fuel cells

9. The apparatus of claim 1 further including a product to coat Proton Exchange Membranes with a catalyst ink onto nafion membranes.

10. The apparatus of claim 9 in which the catalyst is ink is carbon black.

11. The apparatus of claim 1 further including a product to coat a bread with a preservative.

12. The apparatus of claim 1 further including a product to coat a bread with an egg wash

13. A method for shaping a plume of an ultrasonic spray to deposit flux on a surface, comprising:
receiving a gas stream input and a liquid flux stream input; converting the liquid flux stream to an ultrasonic flux spray; shaping the gas stream;
directing the gas stream relatively perpendicular to the ultrasonic flux spray to control a plume shape of the ultrasonic flux spray; and
directing, using the assembly, the ultrasonic flux spray onto a printed circuit board, whereby to deposit the flux upon the printed circuit board.

14. The method of claim 13, further comprising:
directing, using the assembly, the ultrasonic phosphoric doping material spray onto a fuel cell first surface, whereby to deposit the phosphoric doping material upon a fuel cell first surface.

15. The method of claim 14 in which the stream material is a catalyst inks and the fuel cell's first surface is a Proton Exchange Membrane.

16. The method of claim 13 in which the stream material is a transparent conductive oxide and the surface is a surface of a printed circuit board.

17. A means for shaping a plume of an ultrasonic spray to deposit a material on a surface, comprises
receiving means for a gas stream input and a liquid stream input;
means for converting a liquid stream to an ultrasonic spray;
means for shaping a gas stream;
means for directing the gas stream relatively perpendicular to the ultrasonic spray to control a plume shape of the ultrasonic spray; and
means for directing-the ultrasonic spray onto a surface, whereby to deposit the liquid stream upon the surface.

18. The apparatus of claim 3, in which the flat fan hydraulic nozzle is made from brass, stainless steel or Teflon.

19. The apparatus of claim 4 in which the block is stainless steel, Teflon or ertalyte.
